(19) United States
(12) Patent Application Publication
(10) Pub. No.: US 2010/0120534 A1
(43) Pub. Date: May 13, 2010

(54) Touch buttons for gaming machines

(76) Inventors: Milo Borissov, Sharjah (AE); Rossi McKee, Sofia (BG); Dimityr Dimitrov, Sofia (BG)

Correspondence Address: WEIDE & MILLER, LTD., 7251 W. LAKE MEAD BLVD., SUITE 530, LAS VEGAS, NV, 89128, US

(21) Appl. No.: 12/291,826

(22) Filed: Nov. 12, 2008

(51) Int. Cl. A63F 13/00

(52) U.S. Cl. 463/37

(57) ABSTRACT

A touch button assembly and touch buttons are disclosed. The touch button assembly allows a gaming machine to collect player input through one or more touch buttons. The assembly may comprise a support, touch button hardware, and a cover. The support may be attached to the housing of a gaming machine. The button hardware is supported by the support and comprises one or more touch or proximity sensitive sensors. The cover is a substantially contiguous, planar member located over the button hardware and support. The assembly is easy to clean and maintain, and is aesthetically pleasing.

### BACKGROUND OF THE INVENTION

1. Field of the Invention

The invention relates to input devices for gaming machines and, more particularly, a touch button for a gaming machine.

2. Related Art

Various ways of accepting user or player input for electronic devices, such as gaming machines, have been devised. One common input device is a mechanical push-button. The push-button generally has a plunger which may be depressed to activate an electrical switch. These push-buttons have various drawbacks. For example, after a long period of use the moving parts of a push-button may become worn. The moving parts may also accumulate dirt or debris after a long period of use. In addition, the push-buttons generally are configured for a particular use, as they are printed with a button label which can't easily be reconfigured.

Push-buttons also extend outward from a gaming machine or other device and thus create a protrusion there from. This may not be aesthetically pleasing in certain gaming machines or devices. In addition, this causes the push-buttons and their surrounding surfaces to be difficult to clean. In an environment where food and drinks are served, such as in a gaming establishment, this creates additional work for maintenance personnel.

Various alternative inputs devices have been utilized with gaming machines. For example, instead of mechanical push-buttons, gaming machines may include touch-sensitive displays. However, this requires that gaming information which is normally displayed by the machine be displaced at least partially by graphical buttons or other icons. This reduces the size of the displayed gaming information. Further, the combination of gaming information and graphical user interface information can confuse a player.

Thus, an improved input device configuration for a gaming machine is desired.

### SUMMARY OF THE INVENTION

The invention is a touch button assembly for a gaming machine. In general, the touch button assembly has one or more touch buttons which may be activated by player proximity to the touch button and/or engagement of the button. The touch button assembly may be used to collect player input at a gaming machine through its touch buttons.

In one embodiment, the touch button assembly comprises a support configured to attach to a housing or other portion of a gaming machine, a plurality of touch buttons supported by the support, and a cover which covers the touch buttons. Each touch button may comprise a sensor configured to generate an output indicating the proximity of a player to the sensor, an overlying portion of the cover, and one or more feedback devices configured to provide feedback indicating the state of one or more of the plurality of touch buttons. The sensors may be capacitive sensors.

The portion of the cover extends over and protects the one or more sensors. Preferably, the cover includes graphics or other indicia which identify the location of the particular sensors and which identify the function of the sensor.

The touch button assembly may further comprise at least one processor configured to receive sensor output, control the one or more feedback devices to indicate the state of the touch button(s), and communicate the state of the touch button(s) to the gaming machine, whereby the processor determines the state of one or more of the plurality of touch buttons based on the sensor information. For example, based upon a sensor output, the processor may send a signal to a processor of the gaming machine indicating that a player activated one of the sensors.

The one or more feedback devices may be light emitting devices such as LEDs or light bulbs. In addition, the one or more feedback devices may be configured to emit a first color of light to indicate the engaged state of one or more of the touch buttons and to emit a second color of light to indicate the non-engaged state of one or more of the touch buttons. The cover, or a portion thereof, may be configured to allow light to pass there through. In this manner, the player can see the light provided by a feedback device.

The touch button assembly can define as few as one or a plurality of touch buttons. The assembly can be mounted to a gaming machine and be communicatively coupled thereto to provide an output indicative of player input to the gaming machine. The touch button assembly has numerous advantages, including that it requires no moving parts, may have a generally planar environment-resistant cover which is easy to clean and maintain, and presents a user-friendly interface to a player.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a perspective view of an exemplary gaming machine with an embodiment of the invention installed therein;

FIG. 2 is an exploded perspective view of an embodiment of the invention;

FIGS. 3A-3B are perspective views of various embodiments of the button hardware of the invention;

FIGS. 4A-4B are block diagrams of the components of various embodiments of the invention;

FIG. 5 is a perspective view of an assembled embodiment of the invention; and

FIG. 6 is a perspective view of another exemplary gaming machine with an embodiment of the invention installed therein.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises one or more touch buttons which are touch sensitive. This sensitivity allows the touch buttons to collect or receive user input without requiring moving contacts, switches, or other moving parts such as those found in push-type buttons or other traditional mechanical buttons. It is specifically contemplated that the invention may be used with gaming machines; however, it will be understood from the disclosure herein that the invention may be used with other machines or devices. It is noted that, in one or more embodiments, the aspects of the invention which allow touch sensitivity also provide proximity sensitivity. Thus, the invention may also be proximity sensitive in one or more embodiments.

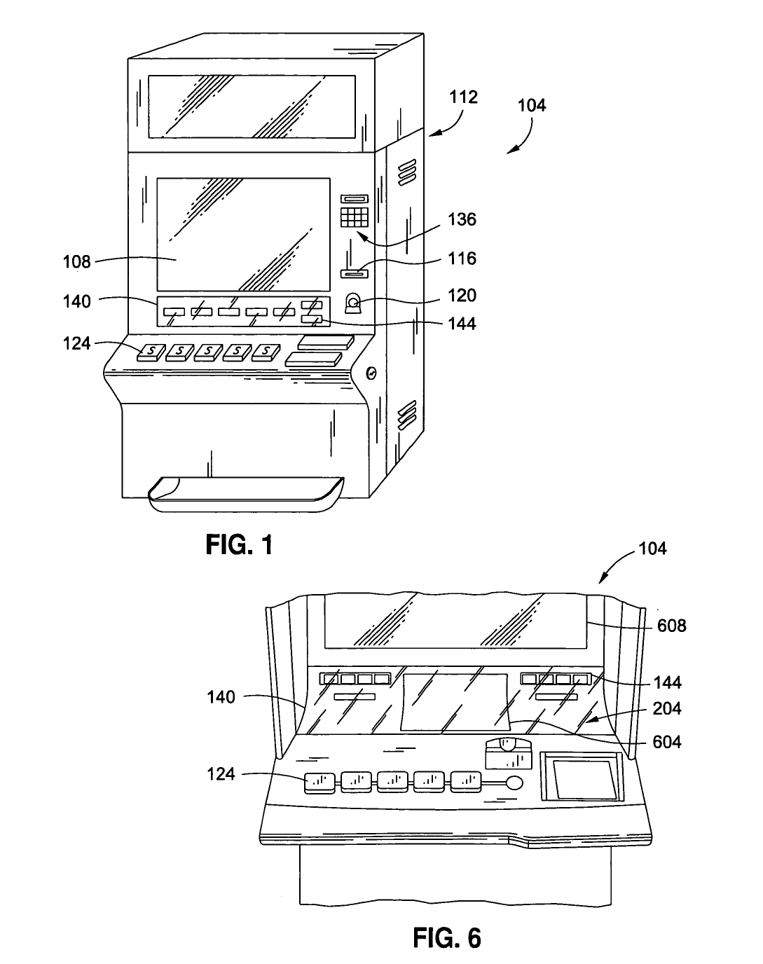

In a preferred embodiment, the invention is used with a gaming machine. FIG. 1 illustrates an exemplary embodiment of such a gaming machine 104. As illustrated, the gaming machine 104 includes a housing 112 for enclosing/supporting various components of the gaming machine. The housing 112 may have a variety of configurations. In one embodiment, the housing 112 is configured so the machine has an “upright” configuration. The machine 104 might also be configured as a “slant”-type, “bar-top” or have other forms. The housing 112 may have various portions, including a main body or cabinet portion, a door, and a top box. The cabinet portion may be configured to house one or more components of the gaming machine 104. The one or more doors may be connected to the cabinet and be configured to move so as to provide access to various portions of the cabinet. The one or more doors or other panels may also support various components of the gaming machine. As indicated, the gaming machine may also include a top box or other additional peripheral features, which portions may also house or support various components of the gaming machine.

In one embodiment, the gaming machine 104 is configured as a “video” type gaming machine, the machine including at least one display 108 for displaying game information to a player. As described below, this game information may include playing card and non-playing card symbols or indicia.

The gaming machine 104 may include other means for providing information to a player. For example, speakers (not shown) or other devices may be provided for generating sound associated with the game. The gaming machine 104 may also include lights, printed instructions and other displays/display devices.

In a preferred embodiment, a player must make payment or wager in order to be entitled to play the game. Preferably, the game is presented as a wagering type game, and a player must place a bet or wager in order to play the game for the opportunity to receive winnings. Preferably, if the player is a winner of the game, the player is provided an award, such as a monetary payout (such as coins), credits representing monetary value, points or tangible prizes. As illustrated, the gaming machine 104 may include a bill validator/acceptor 116 for accepting paper currency and a coin acceptor 120 for accepting coins. Other means of payment, such as a credit card reader, may be provided. An award of winnings in the form of coins may be paid to the player via a coin tray 140.

Preferably, the gaming machine 104 includes means for a player to provide input. In traditional gaming machines, this means comprises one or more push buttons. For example, the push buttons 124 may comprise a plurality of reel “spin” or “select” push buttons to permit a player to hold/select cards in a hand. In addition, as shown, the push buttons 124 may comprise a “bet one” push button or “bet max” push button for a player to select the amount to bet on a particular game.

According to the invention herein, one or more touch buttons 144 may also or alternatively be provided to allow a player to provide input to the gaming machine 104. As illustrated, the touch buttons 144 are part of a touch button assembly 116 which may be embedded, formed integral with, or otherwise attached to the housing 112 of the gaming machine 104. As will be described further below, the touch buttons 144 allow a player to provide input by touching rather than pushing or pressing (e.g. actuating) the button.

A game controller (not shown) is provided for controlling the various devices of the gaming machine and for providing game information. For example, the game controller may be arranged to generate video and audio data for presentation by the display and speakers of the gaming machine 104. The game controller may be arranged to detect a signal from the coin acceptor indicating the receipt of coins or from the bill validator regarding accepted bills and for registering credits corresponding to those inputs, for subtracting credits for wagers placed by a player, and for causing a coin delivery mechanism to deliver coins from a coin hopper to the coin tray 140 for payment of winnings and/or return to a player of unwagered credits. Preferably, the one or more player input devices provide an output to the gaming controller for use in play of the game. For example, in response to a “bet one” input by a player, the gaming controller is preferably transmitted a signal which causes the gaming controller to initiate presentation of the game.

It will be appreciated that the gaming machine 104 may have a variety of configurations, and that the gaming machine 104 illustrated and described above is but an example of a device which may be used with the invention. For example, in one or more embodiments, the gaming machine 104 may be associated with a network and receive game information remotely and may transmit information, such as payout and game play information, to a remote location. For example, a remote master controller may generate game information which is transmitted over a communication link to the gaming machine 104. That information may be utilized by a local controller or processor to present the game, such as by displaying game play data or information.

As indicated, in one embodiment, game information is displayed by a video display 108 to a player. That display may be of a variety of types, including CRT, LCD, plasma and others. The gaming machine 104 may also include more than one video display. In another embodiment, game information which is presented to a player comprises simulated reels displaying game symbols. As indicated, these symbols may be displayed in graphical representation by the display.

In yet another embodiment, the gaming machine 104 may include one or more physical reels capable of displaying symbols. In such a configuration, means are provided for rotating the physical reels. In one or more embodiments, the means may comprise a mechanical linkage associated with a spin arm, with movement of the spin arm (a “pull”) by a player causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference.

The gaming machine 104 may have other configurations, including other features. For example, the gaming machine 104 may include a player tracking device 136, such as a card reader and associated keypad. Such player tracking devices are well known and may permit the game operator to track play of players of the gaming machine. The tracked play may be utilized to offer player bonuses or awards.

In one embodiment, the gaming machine 104 may be configured to dispense media, such as printed paper tickets, which have associated value. For example, winnings or unused credits may be returned to the player through a printed ticket having value or associated value. In one embodiment, the gaming machine 104 might also be configured to accept such media for providing credit for game play. Such systems are well known and thus are not described in detail herein.

As stated, the invention allows a player of the gaming machine 104 to provide input to a gaming machine. Such player input may be used to play a game as described above, or to utilize or interact with other features provided by a gaming machine 104. In one or more embodiments, the invention comprises touch buttons 144 which utilize touch or proximity sensitivity to collect or receive player input.

In general, a touch button 144 comprises a player engageable area detects player proximity to receive input. In various embodiments, a touch button 144 may be engaged by physical contact, or by the player approaching the touch button within a certain proximity, without physically contacting the touch button. As described below, the touch button 144 may also provide player feedback through one or more feedback devices. For example, one or more lights may be activated to indicate that the touch button 144 has been engaged or is activated. In a preferred embodiment, a plurality of touch buttons 144 may be provided as part of a touch button assembly 116.

Touch buttons 144 may be associated with various features or functions of a gaming machine 104. In this manner, each touch button 144 may be used to provide an input, control, or otherwise interact with an associated function or feature of a gaming machine 104. For example, in FIG. 1, a plurality of touch buttons 144 are located below the display 108 of a gaming machine 104. In this exemplary embodiment, the touch buttons 144 are arranged similar to the push buttons 124 of the gaming machine 104. In this configuration, the touch buttons 144 may control the same functions or provide similar input as the push buttons 124 of the gaming machine 104.

To illustrate, the five horizontal touch buttons 144 may be “spin” or “select” buttons used to spin reels or select playing cards, respectively. The pair of vertical touch buttons 144 may be “bet one” and “bet max” buttons to allow a player to place various sized wagers.

As illustrated in FIG. 1, the gaming machine 104 may include one or more mechanical push buttons 124 as we as one or more touch buttons 144 of the invention. This may allow players to choice between using the touch buttons 144 or the push buttons 124. Alternatively, the push buttons 124 and touch buttons 144 may be associated with different gaming machine functions or inputs. In a preferred embodiment, however, the touch buttons 144 may be used instead of push buttons 124 to provide the same functionality but with the above-described benefits of touch buttons.

It is contemplated that touch buttons 144 may be supported by push buttons 124 in one or more embodiments. For example, a push button 124 may have one or more touch buttons 144 on its top surface. In this manner, the push button 124 may be engaged by depressing the push button or by touching or coming within a certain proximity of the touch button(s) 144 on the push button's top surface.

This may be used to reduce player fatigue and increase playability of a game. For instance, in one embodiment, rather than repeatedly depressing a push button 124, a player may simply hold their finger (or other body part) on or near a push button's touch button 144. To illustrate, in a game without an autoplay feature, a player would ordinarily have to repeatedly depress a start button. With a touch button 144 mounted on the start button however, a player may simply hold his or her finger in contact or in proximity to the start button rather than having to depress the start button again and again.

Though FIG. 1 illustrates the touch buttons 144 used as general game inputs, it is noted that other configurations are possible. For example, the touch buttons 144 might be configured as keypad for the player tracking device 136. It will be understood by one of ordinary skill from the disclosure herein that one or more touch buttons 144 of the invention may be utilized as an input device for various different purposes.

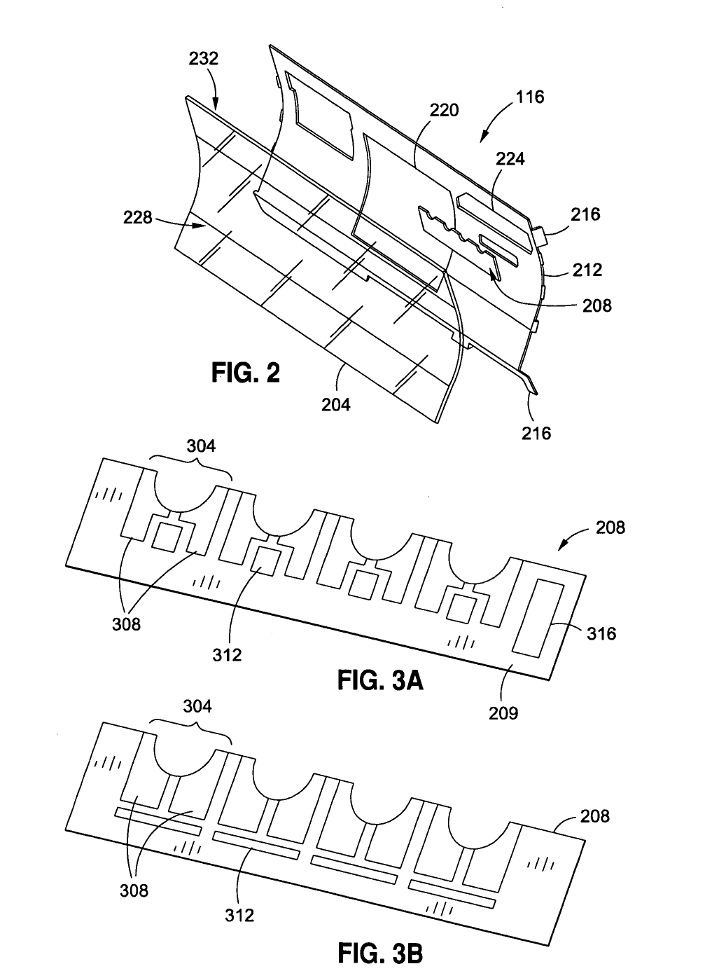

In a preferred embodiment, the one or more touch buttons 144 are part of a touch button assembly 116. FIG. 2 is an exploded view of an exemplary embodiment of a touch button assembly 116 having one or more touch buttons 144. As shown, the touch button assembly 116 comprises a support 212, button hardware 208, and a cover 204. In one or more embodiments, the button hardware 208 provides touch or proximity sensitivity for one or more touch buttons. The button hardware 208 may also provide player feedback to notify players that a touch button has been engaged or that a touch button's function is activated. As will be described further below, player feedback may comprise one or more lights, sounds, or vibrations which are emitted by the button hardware 208 or a portion thereof.

As illustrated in the exemplary embodiment of FIG. 3A, the button hardware 208 may comprise one or more sensors 304, one or more feedback devices 312, and a processor 316. As shown, each sensor 304 is formed integral with or is attached to a circuit board or substrate 209. It is noted however that in some embodiments the one or more sensors 304 may be separate from the substrate 209 and be connected thereto by one or more electrical or other connections. Each of these sensors 304 may be associated with a touch button to provide the touch sensitivity for the button.

The sensors 304 are preferably configured to generate information indicating or detecting the proximity (i.e. distance or physical presence) of a player or the touching of the touch button. Such information is preferably in the form of one or more output signals. The sensor information may then be used to determine when and which touch button has been engaged. For example, it may be determined that a touch button has been engaged when sensor information indicates the player's proximity is such that the player must be in contact with at least a portion of the touch button, such as the touch button's player engageable area, which is described further below.

Each sensor 304 may have one or more detection zones. As referred to herein, a detection zone is generally the area in which a sensor 304 can detect the proximity or touches of a player. For example, a detection zone may be a volume of space around a sensor 304 where the sensor can detect the presence of a player's finger or other body part. The sensor information or output may be communicated electrically. It is noted that some sensors 304 may be capable of communicating optically or wirelessly as well or may include hardware or devices allowing the sensors to communicate optically or wirelessly.

In the embodiment shown in FIG. 3A, the sensors 304 comprise capacitive sensors which detect a change in capacitance caused by the proximity of player to the sensor. Generally, the player's proximity will be the proximity of a player's finger tip to the sensor 304. However, the sensor 304 may detect the proximity of other portions of the player's body as well. As shown, each sensor 304 comprises a pair of electrodes 308 which are spaced apart. An electric field may be generated between the electrodes 308. As a player nears a sensor 304, the electrical field is affected and a change in capacitance may be detected by the electrodes 308. In this manner, the player's proximity to the sensor 304 may be detected by the sensor. The player's distance from each sensor 304 may be determined from the capacitance detected by the sensor 304. For example, increased or decreased capacitance may indicate that a player is close to or far from, the sensor. In one or more embodiments, the sensors 304 may be configured to output sensor information comprising a voltage corresponding to the detected capacitance. As stated, this sensor information may indicate the player's distance, and thus may be used to determine whether or not a touch button 144 has been engaged.

As indicated, a touch button 144 may be activated when the player's finger or other body part is within a particular distance from a sensor 304. In this manner, a player may engage a touch button 144 without physically touching the button hardware 208 or its sensors 304. This allows the button hardware 208 and its sensors 304 to be located behind a covering such as the cover 204 shown in FIG. 2. In this manner, a touch button 144 may be activated when the player is at a distance from the sensor 304 which indicates that the player is touching or is proximate to a portion of the touch button assembly 116, such as the cover 204.

It is contemplated that other types of sensors may be used to detect a player's input and provide a corresponding output. For example, in some embodiments, inductive sensors, acoustic sensors, or pressure sensors may be used. Generally, each sensor will be configured to provide touch or proximity sensitivity to an individual touch button, as described above. However, it is contemplated that a single sensor, including the capacitive sensor described above, may detect a player's proximity to various locations of a touch button assembly. For example, a sensor may be configured to detect the different capacitance, inductance, or acoustic levels which are created depending on the player's proximity to various locations of a touch button assembly. In this way, a single sensor may provide touch or proximity sensitivity for a plurality of touch buttons.

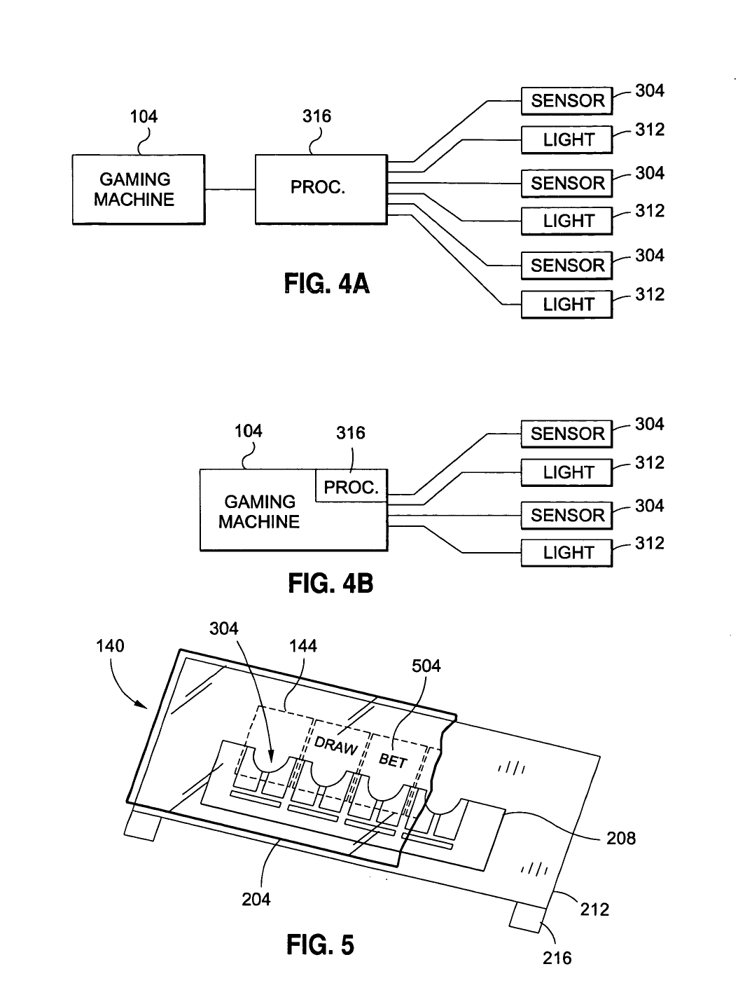

As stated, in one or more embodiments, the button hardware 208 may comprise an associated processor. The processor 316 may be an electrical circuit, microprocessor, or the like (configured as hardware and/or hardware configured to execute machine readable code or software) which is configured to convert the sensor information or output into an output usable by the gaming machine 104. As shown in FIG. 4A, in one or more embodiments, the processor 316 receives information from the one or more sensors 304 and may control other components, such as lights 312. The processor 316 is also communicatively coupled to the gaming machine 104 to provide an output to the gaming machine 104. Such a coupling may comprise a wired or wireless communication link. Such a link may utilize a proprietary protocol, or more preferably, a standardized one such as USB, RS-232 or the like. The processor 316 may provide an output to the gaming machine's controller or other devices associated therewith, such as a communication bus.

As illustrated in FIG. 3A, the processor 316 may be mounted on the circuit board 209. In such a configuration, the sensors 304 may communicate with the processor 316 via leads formed in or on the circuit board 209. Of course, the processor 316 might be external or remote from the sensors 304. For example, the sensors 304 might provide a raw output to a remote processor of the gaming machine. Further, it will be appreciated that there may be one or more processors 316. For example, a processor 316 might be provided relative to each sensor 304 or, as illustrated, be provided relative to a group of sensors 304.

In a preferred embodiment, the sensor output or information from the one or more sensors 304 is interpreted by the processor 316 before being communicated to a gaming machine 104. For example, as stated, sensor information may comprise the information proximity of a player to a sensor. In this case, the processor 316 may be configured to analyze the sensor information to determine whether or not a touch button has been engaged based on the player's proximity to a sensor 304 prior to communicating with a gaming machine 104. In other embodiments, the sensor output might comprise a simple electrical signal, which signal reflects that the touch button is either activated or not activated. If the signal indicates that the sensor is activated, then the processor 316 may send appropriately configured information to the gaming machine.

The communication provided by the processor 316 allows touch buttons to be used with a variety of gaming machines 104. To illustrate, the processor 316 may translate sensor information into signals like that of traditional push buttons or other input devices. In this manner, touch buttons may be used instead of traditional push buttons or input devices without requiring modification to a gaming machine 104. For example, the processor 316 may be configured to complete a circuit or output a certain voltage when the processor determines a touch button has been engaged. In this manner, the gaming machine 104 receives a signal like that of a traditional button or contact switch.

In addition to information indicating whether or not a sensor is engaged, the processor 316 may be configured to communicate other information to a gaming machine 104. For example, the processor 316 may communicate information indicating which sensor 304 is being activated. In this manner, input to different sensors/button can result in different actions by the gaming machine 104.

The processor 316 may also be configured to communicate how long a touch button has been engaged. For example, the processor 316 may send information indicating that a touch button is being engaged for as long as the sensor information indicates that a player is engaging the button. Alternatively, the processor 316 may communicate that a touch button has been engaged when the touch button has been engaged and communicate that the touch button has been disengaged when the touch button is disengaged. This allows a gaming machine 104 to provide respond to a player's “holding down” a touch button, and may be used to allow a gaming machine to accept input analogous to double clicking a mouse (e.g. double tapping a touch button). In one embodiment, the processor 316 may communicate the player's distance from a sensor 304 to allow a gaming machine 104 to respond to the player's proximity as well as the player's touch.

It is contemplated that the processor 316 may repeatedly send signals indicating a touch button has been engaged for as long as the player is in contact with or within a particular distance from a touch button. In this manner, to a gaming machine, it appears that the player is repeatedly engaging the touch button. This is advantageous where the player would ordinarily have to physically engage the touch button repeatedly such as when scrolling through one or more options of a game.

As indicated, it is contemplated that sensor information may be sent directly from one or more sensors 304 to the gaming machine 104 in some embodiments. Thus, a processor 316 may not be provided directly as part of the touch button, as illustrated in FIGS. 3B and 4B. As shown, the one or more sensors 304 may directly provide an output to the gaming machine 104. The gaming machine 104 may itself include a processor 316, such as described above, to translate sensor information, or the sensors 304 may provide sensor information which is usable by a gaming machine without translation. For example, some kinds of sensors 304, including embodiments of the sensors described above, may provide sensor information which indicates that a touch button has been engaged rather than sensor information which indicates a player's proximity. It is contemplated that these sensors 304 may be directly connected to a gaming machine 104 as the sensor information they provide may be used by a gaming machine without conversion.

Referring to FIGS. 3A-3B, the button hardware 208 may provide player feedback through one or more feedback devices 312 or status indicating devices in one or more embodiments. Player feedback is advantageous because it allows players to ascertain the state of a touch button. Feedback may be provided when a touch button is engaged, not engaged, activated, or not activated. For example, a feedback device 312 may provide player feedback when a touch button is engaged by a player to confirm to the player that the button has indeed been engaged or activated. When the player disengages the touch button, such feedback may no longer be provided or it may be replaced with feedback confirming to the player that the button is indeed no longer engaged.

Similarly, feedback confirming that a touch button is activated may be provided when a touch button is activated. Such feedback may be stopped or replaced with other feedback confirming the touch button is no longer activated when the touch button is not activated. Activation of a touch button generally means that the touch button's associated function has been activated or turned on. For example, a “hold” button on a gaming machine has the function of holding a card for the next deal. Unique feedback may be provided to a player to indicate that a touch button is activated rather than engaged.

As shown in FIGS. 3A-3B, the feedback devices 312 may be any device capable of providing perceivable notification of a touch button's state to a player. Feedback devices 312 may include sound emitters, vibrators, light emitting devices, or combinations thereof. One or more feedback devices 312 may be associated with a touch button such as by being located adjacent the touch button's sensor 308. This allows the feedback devices 312 to provide feedback for individual touch buttons. It is contemplated that the feedback devices 312 may be located at various locations as long as feedback for one or more touch buttons may still be perceived by players. For example, a light may preferably be located near a touch button to allow the light to provide feedback by illuminating the touch button while a speaker may be positioned further away from a touch button and still provide the desired feedback.

In a preferred embodiment, the feedback device 312 comprises a light emitter such as an LED, a light bulb, or the like. Each light emitter feedback device 312 may emit one or more colors which represent various touch button states. For example, one color may be emitted for button engagement while another color is emitted when the button is not engaged. In addition, other colors may be emitted for activation or non-activation button states. It is contemplated that a light emitter feedback device 312 may be turned off to indicate some button states. For example the light emitter feedback device 312 may be turned off when a touch button is not engaged or not activated. Additionally, light emitter feedback devices 312 may blink or flash or emit light in different colors to indicate touch button states or to get a player's or other person's attention.

In one embodiment, the processor 316 may control the feedback devices 312 based on sensor information from the sensors 304. Referring to FIG. 4A, the processor 316 may receive sensor information indicating that a touch button has been engaged and in response activate a feedback device 312 associated with the touch button. In this embodiment, the processor 316 may be directly connected to one or more feedback devices 316.

It is noted that the feedback devices 312 may alternatively be connected to and controlled by a gaming machine 104. This is illustrated in FIG. 4B. In these embodiments, the gaming machine 104 may include a processor 316 which controls the feedback devices 312, as described above, or the gaming machine 104 may directly control the feedback devices with other devices or hardware. For example, the gaming machine 104 may already include hardware capable of controlling one or more lights for traditional push buttons. It is contemplated that the same hardware may be used to control feedback devices 312, such as but not limited to lights, of the button hardware 208.

In one or more embodiments, the touch button 144 of the invention, and thus the touch button assembly 116, further comprises a cover 204. An exemplary cover 204 is illustrated in FIG. 2. The cover 204 covers or extends over one or more elements of the touch button assembly 116. In one embodiment, the cover 204 covers the button hardware 208 and support 212. Preferably, the cover 204 covers the entire support 212 and the button hardware 208 so that such are not accessible from the exterior of the gaming machine. Such a configuration is illustrated in FIGS. 1 and 6. The cover 204 may also extend beyond the support 212 and cover a portion of the gaming machine 104. For example, it is contemplated that the cover 204 may cover the support 212 as well as one or more displays 108 of a gaming machine 104. In this manner, the cover 204 provides its benefits to the gaming machine 104 as well as the touch button assembly 116.

The cover 204 is beneficial in that it protects the elements of the touch button assembly 116 and, in one or more embodiments, helps to prevent unauthorized access to the assembly's or a gaming machine's internal elements. In addition, in one or more embodiments, the cover 204 provides a substantially planar surface which is easy to clean and maintain.

FIG. 5 illustrates an assembled embodiment of the touch button assembly 116. As illustrated, the cover 204 may also provide or define particular player engageable areas 508 corresponding to the one or more touch buttons 144. For example, a player engageable area 508 may be a portion of the cover 204 within the detection zone of at least one sensor 304. In this manner, a player may touch the player engageable area 508 to activate a touch button 144. As described below, printing, graphics or the like may be formed in or be associated with the cover 204 to identify the player engageable areas 508 and their associated functions to one or more players. For example, the cover 204 may have areas which are labeled with “spin”, “draw”, “bet one” or the like, corresponding to the particular sensors which correspond to those functions. One advantage of the assembly 116 is that the cover 204 can be removed and replaced, thereby changing the designations of the various touch buttons 144. For example, sensors of the assembly 116 as used at one gaming machine may correspond to “draw/replace” functions for a video poker game, and the cover 204 may be appropriately labeled. The same assembly 116 may be used at a slot machine where the sensors provide a “spin” input, where only the cover 204 labeling differs. It will also be appreciated that other labeling or identification can be utilized, such as illuminated text, lights or the like.

The cover 204 may have various configurations and comprise various materials. For example, the cover 204 may be a generally planar, contiguous sheet of plastic, glass, fabric, or other material. The cover 204 may be relatively rigid in configurations where the sensors detect the proximity of the user, or flexible in cases where the sensors detect touch input. Preferably, at least the exterior surface of the cover 204 is generally smooth, making the cover appealing in appearance and touch. The cover 204 may be relatively thin in order to ensure that the one or more sensors located behind the cover 204 can detect the proximity of a user.

Preferably, graphics or indicia are associated with the cover 204 to provide information regarding the location of the one or more touch buttons and/or the function of the buttons. As shown in FIG. 1, for example, each touch button 144 may be represented by a rectangular graphic applied to the touch button assembly's 116 cover 204. In this manner, players can easily determine the location of the particular touch buttons relative to the assembly 116. As shown in FIG. 5, indicia may also identify the function of each button.

The graphics, printing, labeling or the like may be applied or associated with the cover 204 in various ways. In one embodiment, the cover 204 comprises a front side 228 and a back side 232 with the front side configured to face a player, and the back side facing the circuit board 209 and other elements of the touch button assembly 116. Graphics representing a touch button may be applied or associated to the cover 204 on its front side 228, back side 232, or both. The cover 204, or a portion thereof, may be transparent or translucent to allow graphics at the back side 232 to be visible. It is beneficial to have graphics located at the back side 232 because they are protected from wear by the cover 204. In one embodiment, graphics are applied to a cover 204 by printing the graphics on the cover. In another embodiment, graphics are associated with a cover 204 by providing a template. The template may be a substrate upon which the graphics are printed or otherwise applied. The template may then be secured at the back side 232 of the cover 204. The template may also be secured to the front side 228 of the cover if desired. It is noted that a template may be combined with graphics associated on the cover 204. For example, the border of a touch button may be associated with the cover 204 while the button labels are printed on a template. Graphics may also be integral with the cover 204. For example, the graphics may be one or more transparent or translucent text labels, symbols, or the like that are integral with the cover 204. These graphics provide the benefit of allowing light to pass there through. Thus, the graphics may be backlit and feedback from light emitting feedback devices may be perceived by a player. It is noted that instead of printing, it is possible for the location of the buttons and their function to be provided by lighting, such as small LCDs, back lighting of transparent areas of the cover 204 (as compared to opaque areas), or the like.

The cover 204 and the button hardware 208 may be attached to a support 212 in one or more embodiments. In general, the support 212 provides a structure to which other elements of the touch button assembly 116, such as the button hardware 208 and the cover 204, may be attached. These elements may be attached to the support 212 by one or more fasteners, adhesives, welds, or the like. In addition, the elements may be configured to attach to the support by a friction fit, or a snap-in fit. It will be understood that other ways of attaching elements to the support 212 may be used as well. In other embodiments, the cover 204 may be directly connected to the gaming machine and simply extend over the button hardware 208.

In some embodiments, the support 212 or a portion thereof may be configured to accept the button hardware 208. For example, the support 212 may include an aperture 224 or inset where the button hardware 208 can be placed and secured. The support 212 may be configured to attach to the housing of a gaming machine in one or more embodiments. For example, as shown in FIG. 2 the support 212 comprises tabs 216 which allow the support to be attached to a gaming machine's housing. The support 212 may be secured to a housing by one or more fasteners, adhesives, welds, or the like, or the support may be configured for a friction or snap-in fit to secure the support to the housing. Of course, other ways of attaching the support 212 to the housing may be used as well. It is noted that some gaming machines may have a support 212 or a support-like structure and thus a separate support may not be provided in all embodiments.

The support 212 may provide a substantial portion of the structure of a gaming machine's housing as well. As can be seen from FIGS. 2 and 6, the support 212 forms a large portion of the gaming machine's 104 housing 112 between the display 608 and the push buttons 124. The cover 204 extends beyond the touch buttons 144 to provide a planar area covering the support 212. In this manner, a substantial portion of the gaming machine 104 is provided by the touch button assembly 116.

In one or more embodiments, the support 212 is comprised of a rigid material such as metal. It will be understood that plastic, glass, or other suitable materials may be used as well. The support 212 may be planar in shape in one or more embodiments, or may be shaped in other ways so as to conform to the housing of a gaming machine, to allow elements of the touch button assembly 116 to be positioned at a desired location, to provide an aesthetically pleasing shape, or a combination thereof. For example, the support 212 of FIG. 2 curves along its vertical axis to conform to the shape of the gaming machine's housing 112. As another example, the support 212 of the touch button assembly 116 may be planar to suit the flat front of its gaming machine's 104 housing 112 such as shown in FIG. 1.

As shown in FIGS. 2 and 6, in some embodiments, the support 212 may include one or more other apertures or openings 220. Such an aperture or opening 220 may be configured to allow a portion or component of the gaming machine 104 to be visible or accessible through the support 212. For example, as illustrated in FIG. 6, a portion of a display 604 of a gaming machine 104 may be visible or accessible through one or more openings 220 in the support 212. If physical access to a component of a gaming machine 104 is desired, a corresponding opening may be formed in the cover 204 in one or more embodiments. For example, an opening may be formed in the support 212 and the cover 204 to allow access to a gaming machine's 104 card reader.

The support 212 and thus the touch button assembly 116 may be positioned at various locations of a gaming machine. As illustrated in FIG. 1 for example, the touch button assembly 116 may be located below a gaming machine's 104 main display 108. In this location, the touch button assembly 116 may be well suited to provide touch buttons 144 for game play. In another embodiment, the touch button assembly 116 may be located near the gaming machine's card reader. In this location, the touch button assembly 116 may provide touch buttons 144 which form a keypad for a gaming machine's player tracking device. Of course, the touch button assembly 116 may be located at other locations as well, including at a console portion thereof at which traditional push-buttons would normally be located. In one embodiment, for instance, a touch button assembly 116 may be of relatively small size and located on the top surface of a traditional push button.

In accordance with the invention, a touch button preferably comprises a touch or proximity sensitive sensor, and preferably at least a portion of a cover. Preferably, the touch button is part of a touch button assembly 116 which further comprises a support 212 and at least one processor. In other embodiments, however, the touch button assembly 116 may have a plurality of touch buttons 144. In such a configuration, the assembly 116 includes multiple sensors and may include a single cover having areas corresponding to the various sensors, or even multiple covers.

FIG. 5 illustrates how the elements of the invention may be located relative to one another when the invention is assembled. It is noted that only a portion of the cover 204 is shown, and that portion is illustrated as transparent to better illustrate the invention. As can be seen from FIG. 5, the button hardware 208 is secured to the support 212 with the cover 204 positioned such that it covers the button hardware.

As stated, the cover 204 may also have graphics which identify the location of the touch buttons 144. FIG. 5 illustrates indicia 504 used to identify the location of a touch button 144 and its associated function. In the case where a sensor 304 is capable of detecting touches at multiple locations, multiple graphic indicators of touch buttons may be positioned within the detection zone of a sensor. In this manner, a single sensor 304 may be used to provide touch or proximity sensitivity for a plurality of touch buttons 144.

In a preferred embodiment, the touch button assembly 116 includes a plurality of touch buttons 144. In this manner, a single cover 204 may be used for multiple touch buttons 144. This protects the touch buttons 144 from dirt and debris because there are not cracks or crevices around the touch buttons which would allow dirt or debris in. In addition, this provides a sleek modern appearance which is also easy to clean in that the surface of the cover 204 may be substantially smooth.

As shown by the exemplary embodiment of FIG. 6 and described briefly above, the cover 204 may extend over more than just the touch buttons 144. As illustrated, a larger portion of the gaming machine 104 may be covered by the cover 204. For example, the cover 204 may cover one or more other components of the gaming machine, with the button hardware 208 located behind just a portion of the cover. For example, as illustrated, the cover 204 may extend over a portion of a display 604 of the gaming machine (that portion being transparent for viewing of the display there through). In this manner, a single cover 204 provides an unbroken surface covering a larger portion of the gaming machine 104. This allows the area covered by the cover 204 to be easily cleaned, and provides an aesthetically pleasing appearance while protecting the gaming machine's 104 displays 608 or reels and other components.

While the touch button assembly 116 preferably includes a support 212, it is possible for the button hardware 208 to be mounted directly to a portion of the gaming machine, such as a housing thereof. In the preferred configuration in which the assembly 116 includes a support 212 and cover 204, the assembly 116 can comprise a single unit that can be shipped, connected and disconnected from a gaming machine, without individually connecting the various components thereof.

The invention has numerous advantages. First, a user-friendly player input device is provided. This input device permits a user to provide input by touching a particular element or area and/or coming into proximity to the element or area. Thus, a user does not need to use substantial physical effort to push a mechanical button, but can instead lightly touch an area of the touch button of the invention, or even only place a finger or the like near the button. This reduces the effort needed to provide input.

The touch button of the invention also has the advantage of being configurable to accept multiple inputs. In the prior art, a different mechanical push-button is required for each particular input. In accordance with the invention, an assembly may include multiple sensors defining a plurality of touch buttons. Thus, a single assembly or panel may define multiple touch buttons. Thus, by connecting a single assembly to a gaming machine, the machine may be configured to receive a multiplicity of different inputs.

As indicated, yet another advantage of the invention is that the touch button has no moving parts. Thus, the touch button has longevity and does not need to be serviced or replaced during the lifetime of the gaming machine. This reduces maintenance costs associated with gaming machines. In addition, the “closed” nature of the push-button in which a protective cover extends over the button hardware protects the touch button from damage, debris and the like. This is contrary to mechanical push-buttons where dirt, liquids and the like may enter the space between the body of the button and the depressible button.

The touch button of the invention is also desirable in appearance. In particular, as indicated, a cover may define a smooth and contiguous surface which is futuristic or modern in appearance.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A touch button assembly for a gaming machine comprising:
a support configured to attach to a housing of the gaming machine;
a cover configured to substantially cover the entire support;
a plurality of touch buttons having at least an engaged state and a non-engaged state, one or more of the plurality of touch buttons comprising:
a sensor configured to generate sensor information comprising the proximity of a player to the sensor, the sensor mounted to the support;
a player engageable area comprising a portion of the cover, the player engageable area being within the detection zone of the sensor; and
one or more feedback devices configured to provide feedback indicating the state of the one or more of the plurality of touch buttons, the one or more feedback devices mounted to the support; and
a processor configured to receive the sensor information, control the one or more feedback devices to indicate the state of one or more of the plurality of touch buttons, and communicate the state of one or more of the plurality of touch buttons to the gaming machine, whereby the processor determines the state of one or more of the plurality of touch buttons based on the sensor information.

2. The touch button assembly of claim 1, wherein the support forms a portion of the housing of the gaming machine.

3. The touch button assembly of claim 1, wherein the cover is configured to cover a substantial portion of the entire support and a portion of the gaming machine.

4. The touch button assembly of claim 1, wherein the support comprises one or more openings to allow one or more components of the gaming machine to pass there through, and wherein the cover is configured to cover the one or more components of the gaming machine.

5. The touch button assembly of claim 1, wherein the player engageable area of one or more of the plurality of touch buttons further comprises one or more graphics configured to indicate the location of the one or more of the plurality of touch buttons.

6. The touch button assembly of claim 1, wherein the processor communicates the engaged state of one of the plurality of touch buttons to the gaming machine when the player is touching the player engageable area of the touch button, and communicates the non-engaged state of the touch button to the gaming machine when the player is not touching the player engageable area of the touch button.

7. The touch button assembly of claim 1, wherein the sensor of one or more of the plurality of touch buttons is a capacitive sensor.

8. The touch button assembly of claim 1, wherein the one or more feedback devices are light emitting devices selected from the group consisting of one or more LEDs and light bulbs.

9. The touch button assembly of claim 8, wherein the one or more feedback devices are configured to emit a first color of light to indicate the engaged state of one or more of the plurality of touch buttons and to emit a second color of light to indicate the non-engaged state of one or more of the plurality of touch buttons.

10. The touch button assembly of claim 8, wherein at least a portion of the player engageable area of one or more of the plurality of touch buttons is configured to allow light from the one or more feedback devices to pass there through.

11. A touch button assembly for a gaming machine comprising:
a support comprising a body having one or more openings therein to allow one or more components of the gaming machine to pass there through, the support configured to attach to the housing of the gaming machine;
a cover configured to substantially cover the entire support; and
a plurality of touch buttons having at least an engaged and non-engaged state, one or more of the plurality of touch buttons comprising:
button hardware configured to communicate one or more signals indicating the state of one or more of the plurality of touch buttons to the gaming machine, the button hardware mounted to the support; and
a player engageable area comprising a portion of the cover within the detection zone of the button hardware.

12. The touch button assembly of claim 11, wherein the button hardware is configured to communicate one or more signals indicating the engaged state of one of the plurality of touch buttons to the gaming machine when the player is touching the player engageable area of the touch button, and to communicate one or more signals indicating the non-engaged state of the touch button to the gaming machine when the player is not touching the player engageable area of the touch button.

13. The touch button assembly of claim 11, wherein the cover is configured to substantially cover the entire support and a portion of the gaming machine.

14. The touch button assembly of claim 11, wherein the button hardware comprises:
one or more sensors configured to generate sensor information; and
a processor configured to receive the sensor information and determine the state of one or more of the plurality of touch buttons based on the sensor information;
wherein the processor provides the one or more signals indicating the state of one or more of the plurality of touch buttons to the gaming machine.

15. The touch button assembly of claim 14, wherein the one or more sensors are one or more capacitive sensors configured to generate sensor information indicating the proximity of the player to the one or more capacitive sensors.

16. The touch button assembly of claim 11, wherein the button hardware comprises one or more feedback devices configured indicate the state of one or more of the plurality of touch buttons.

17. The touch button assembly of claim 11, wherein the button hardware comprises one or more light emitters configured to emit light in one or more colors to indicate the state of one or more of the plurality of touch buttons.

18. The touch button assembly of claim 17, wherein the player engageable area of one or more of the plurality of touch buttons is configured to allow the passage of light from the one or more light emitters there through.

19. The touch button assembly of claim 11, wherein the player engageable area of one or more of the plurality of touch buttons comprises one or more graphics configured to indicate the location of one or more of the plurality of touch buttons to the player.
